(19) United States
(12) Patent Application Publication
(10) Pub. No.: US 2006/0256496 A1
(43) Pub. Date: Nov. 16, 2006

(54) Methods and apparatuses related to pulsed power

(76) Inventor: M. Collins Clark, CouAlbuquerque, NM (US)

Correspondence Address: V. Gerald Grafe, esq., P.O. Box 2689, Corrales, NM, 87048, US

(21) Appl. No.: 11/433,031

(22) Filed: May 12, 2006

Related U.S. Application Data
(60) Provisional application No. 60/680,674, filed on May 13, 2005.
(60) Provisional application No. 60/775,292, filed on Feb. 21, 2006.

(51) Int. Cl. H02H 9/06

(52) U.S. Cl. 361/118

(57) ABSTRACT

The present invention can comprise a surge suppressor apparatus, including a plurality of surge arrestor elements. Metal oxide varistors can be suitable as surge arrestor elements. Each surge arrestor element has two terminals, and allows current flow through the element between the first and second terminals. The surge arrestor elements can be arranged in an electrical series circuit, and are mounted so that current in one surge arrestor element is in a direction substantially opposite the direction of current in an adjacent surge arrestor element. The opposite direction current flow can reduce the inductance of the surge suppressor apparatus and can aid in shielding the apparatus. A surge arrestor element can also mount within a return conductor, such that the return conductor shields the surge arrestor element and reduces the inductance. The invention also includes various configurations and applications.

### CROSSREFERENCE TO RELATED APPLICATIONS

This application claims the benefit of U.S. provisional application 60/680,674, “Methods and Apparatuses Related to Pulsed Power,” filed May 13, 2005, incorporated herein by reference, and the benefit of U.S. provisional application 60/775,292, “Pulsed Power System,” filed Feb. 21, 2006, incorporated herein by reference.

### BACKGROUND

The present invention relates to methods and apparatuses related to pulsed power. More specifically, the present invention relates to circuits and devices suitable for use in shaping pulses in pulsed power systems, and pulsed power systems incorporating such circuits or devices.

Pulsed power is used to generate and apply energetic beams and high-power energy pulses. It is distinguished by the development of repetitive pulsed power technologies, x-ray and energetic beam sources, and electromagnetic and radiation hydrodynamic codes for a wide variety of applications. Examples of these applications include: High power Microwave beam generation; Nuclear survivability and hardness testing; Measurement of material properties; Z-pinch-driven inertial confinement fusion; Materials processing; Waste and product sterilization and food purification; Electromagnetically-powered transportation; and Interpreting data from x-ray binaries and galactic nuclei.

Pulsed power applications such as these place extraordinary demands on the devices used for power production. In particular, the requirements for pulse width range from nanoseconds to many milliseconds, the currents from amperes to many kiloamperes and the voltages from a few kilovolts to well in excess of one million volts. Using prior art, it is necessary to employ a number of unique pulsed power driver solutions to span this large parameter range. Each solution requires individual development and implementation which must be repeated for each separate application. It is often desirable to combine the best features of each technique into an optimized solution for existing or new applications but this is not possible with the prior art. Therefore there is a need for circuits and devices that are capable of combining the best features of each into a single concept such as that exhibited by the characteristics of this invention. In particular, there is a need for improvements in pulsed power systems that can provide simple, easy adjustment of operating parameters such as pulse width and output current.

### SUMMARY OF THE INVENTION

The present invention can comprise a surge suppressor apparatus, including a plurality or surge arrestor elements. Metal oxide varistors can be suitable as surge arrestor elements. Each surge arrestor element has two terminals, and allows current flow through the element between the first and second terminals. The surge arrestor elements are arranged in an electrical series circuit, and are mounted so that current in one surge arrestor element is in a direction substantially opposite the direction of current in an adjacent surge arrestor element. The opposite direction current flow can reduce the inductance of the surge suppressor apparatus and can aid in shielding the apparatus.

Embodiments of the invention further mount the surge arrestor elements such that each surge arrestor element mounts adjacent to a surge arrestor element having current flow in a direction substantially opposite the direction of current flow in the surge arrestor element. The surge arrestor elements can be configured such that current flow in each surge arrestor element defines an axis, and mounted relative to each other such that the axes are substantially parallel. Connecting the terminals of adjacent surge arrestor elements to produce an electrical series circuit can then have current in each surge arrestor element substantially opposite current in an adjacent surge arrestor element, reducing the inductance of the apparatus and aiding in shielding the elements. Embodiments of the present invention can mount the surge arrestor elements such that their axes intersect a single straight line or a curve in two dimensions. Terminals of the surge arrestor elements can be electrically connected with metallic elements, for example with metallic elements pressed against the terminals.

The present invention also comprises a system for producing a shaped electrical waveform using a surge suppressor apparatus as described above. The system comprises an electrostatic energy storage system, capable of storing electrical energy and producing a potential above a ground or reference potential. The system further comprises an inductor, placed in electrical communication with the electrostatic energy storage system. A second terminal of the inductor is placed in electrical communication with the surge suppressor apparatus, and with a load or output terminal of the system.

The electrostatic energy storage system can comprise a plurality of capacitors mounted relative to each other, as in a conventional Marx generator. The surge arrestor elements can be mounted relative to the capacitors such that capacitors charged to high voltages mount proximal surge arrestor elements that experience high voltages in operation. Such placement can aid in shielding the system.

The present invention can also provide a surge suppressor system comprising a surge arrestor element mounted with a return conductor. The return conductor can be configured so that current flow through the surge arrestor element is balanced by current in the return conductor. As an example, a return conductor can be mounted with a surge arrestor element such that the return conductor connects to the surge arrestor element at one end thereof, and extends toward the other end of the surge arrestor element, effectively surrounding the surge arrestor element in directions perpendicular to the direction of current flow through the surge arrestor element. The return conductor can physically surround the surge arrestor element, such as when a cylindrical surge arrestor element is mounted within and coaxial with a larger diameter return conductor. The return conductor can also effectively surround the surge arrestor element by providing periodic conductors, such as a plurality of conductive bars or rods extending from the connected end of the surge arrestor element toward the other end of the surge arrestor element.

The return conductor can be spaced apart from the surge arrestor element by a first distance near the connected end, and by a greater distance near the other end. The voltage difference between the surge arrestor element and the return conductor can be lowest at the connected end, and the greatest at the other end. Separation by a larger distance at the unconnected end can provide desirable electrical isolation where the potential difference is greatest.

The advantages and features of novelty that characterize the present invention are pointed out with particularity in the claims annexed hereto and forming a part hereof. However, for a better understanding of the invention and the methods of its making and using, reference should be made to the drawings which form a further part hereof, and to the accompanying descriptive matter in which there are illustrated and described preferred embodiments of the present invention. The description below involves several specific examples; those skilled in the art will appreciate other examples from the teachings herein, and combinations of the teachings of the examples.

### BRIEF DESCRIPTION OF THE DRAWINGS

FIG. 1 is a schematic illustration of an example circuit for a pulsed power system incorporating a surge suppressor according to the present invention.

FIG. 2 is a schematic illustration of a surge suppressor system with a return conductor.

FIG. 3 is a schematic illustration of a surge suppressor system having a plurality of surge arrestor elements in a series circuit and arranged such that current flows in opposite directions in adjacent surge arrestor elements.

FIG. 4 is a schematic illustration of a surge suppressor system having a plurality of surge arrestor elements is series and arranged along a curve in two dimensions.

FIG. 5 is a schematic illustration of a surge suppressor system having a plurality of surge arrestor elements disposed within and coaxial with a return conductor.

FIG. 6 is a graph of two dimensional electrostatic simulation results for the system depicted in FIG. 5.

FIG. 7 is a schematic illustration of a Marx generator having switches according to the present invention.

FIG. 8 is a schematic illustration of a Marx generator having switches and surge suppressor systems according to the present invention.

FIG. 9 is a schematic illustration of the addition of a surge suppression system according to the present invention added to a conventional Marx generator system.

FIG. 10 is a schematic illustration of the application of a surge suppression system according to the present invention applied to driving a high power microwave load.

FIG. 11 is a schematic illustration of a surge suppression system according to the present invention in application.

FIG. 12 is a schematic illustration of an example circuit for a pulsed power system incorporating a surge suppressor according to the present invention.

FIG. 13 is a schematic depiction of performance characteristics of a system such as that shown in FIG. 12.

FIG. 14 is a schematic illustration of an example embodiment of the present invention.

### DESCRIPTION OF THE INVENTION

The present invention can comprise a surge suppressor apparatus, including a plurality or surge arrestor elements. Metal oxide varistors can be suitable as surge arrestor elements. Each surge arrestor element has two terminals, and allows current flow through the element between the first and second terminals. The surge arrestor elements are arranged in an electrical series circuit, and are mounted so that current in one surge arrestor element is in a direction substantially opposite the direction of current in an adjacent surge arrestor element. The opposite direction current flow can reduce the inductance of the surge suppressor apparatus and can aid in shielding the apparatus.

Embodiments of the invention further mount the surge arrestor elements such that each surge arrestor element mounts adjacent to a surge arrestor element having current flow in a direction substantially opposite the direction of current flow in the surge arrestor element. The surge arrestor elements can be configured such that current flow in each surge arrestor element defines an axis, and mounted relative to each other such that the axes are substantially parallel. Connecting the terminals of adjacent surge arrestor elements to produce an electrical series circuit can then have current in each surge arrestor element substantially opposite current in an adjacent surge arrestor element, reducing the inductance of the apparatus and aiding in shielding the elements. Embodiments of the present invention can mount the surge arrestor elements such that their axes intersect a single straight line or a curve in two dimensions. Terminals of the surge arrestor elements can be electrically connected with metallic elements, for example with metallic elements pressed against the terminals.

The present invention also comprises a system for producing a shaped electrical waveform using a surge suppressor apparatus as described above. The system comprises an electrostatic energy storage system, capable of storing electrical energy and producing a potential above a ground or reference potential. The system further comprises an inductor, placed in electrical communication with the electrostatic energy storage system. A second terminal of the inductor is placed in electrical communication with the surge suppressor apparatus, and with a load or output terminal of the system.

The electrostatic energy storage system can comprise a plurality of capacitors mounted relative to each other, as in a conventional Marx generator. The surge arrestor elements can be mounted relative to the capacitors such that capacitors charged to high voltages mount proximal surge arrestor elements that experience high voltages in operation. Such placement can aid in shielding the system.

The present invention can also provide a surge suppressor system comprising a surge arrestor element mounted with a return conductor. The return conductor can be configured so that current flow through the surge arrestor element is balanced by current in the return conductor. As an example, a return conductor can be mounted with a surge arrestor element such that the return conductor connects to the surge arrestor element at one end thereof, and extends toward the other end of the surge arrestor element, effectively surrounding the surge arrestor element in directions perpendicular to the direction of current flow through the surge arrestor element. The return conductor can physically surround the surge arrestor element, such as when a cylindrical surge arrestor element is mounted within and coaxial with a larger diameter return conductor. The return conductor can also effectively surround the surge arrestor element by providing periodic conductors, such as a plurality of conductive bars or rods extending from the connected end of the surge arrestor element toward the other end of the surge arrestor element.

The return conductor can be spaced apart from the surge arrestor element by a first distance near the connected end, and by a greater distance near the other end. The voltage difference between the surge arrestor element and the return conductor can be lowest at the connected end, and the greatest at the other end. Separation by a larger distance at the unconnected end can provide desirable electrical isolation where the potential difference is greatest.

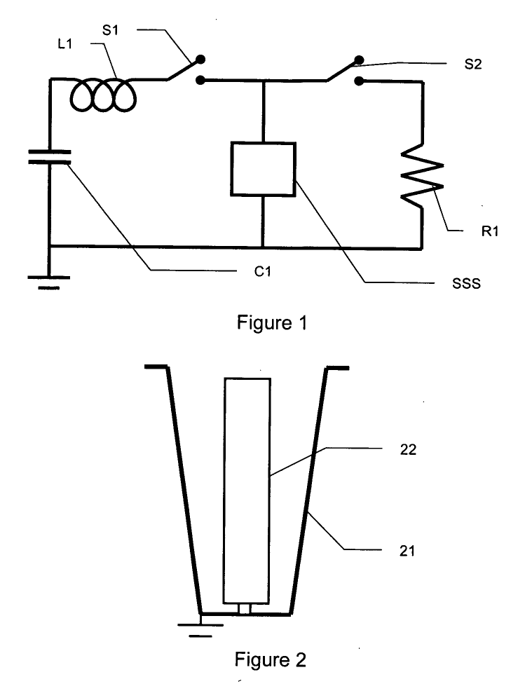

FIG. 1 is a schematic illustration of an example circuit for a pulsed power system incorporating a surge suppressor according to the present invention. An energy source C1 (often a capacitor or multi-capacitor system) connects with an inductive system (represented by inductor L1 in the figure). A switch S1 allows the energy source to be selectively connected to a load resistor. A second switch S2 allows the energy source to be first connected to a surge suppression system SSS then to the load resistor R1. The energy source, surge suppression system and load resistor can be connected to a common reference voltage (e.g., ground). A suitable surge suppression system can comprise a metal oxide varistor. For some high voltage applications, however, a suitable metal oxide varistor can exceed 1 meter in length. The associated inductance can severely limit performance of the system if significant current is required.

Some pulsed power applications require surge suppressor systems to operate at about 500 kV, carrying 20 kA, with rise times of less than 30 nS. This can indicate that the total inductance of the surge suppressor system should be less than 1 uH. In contrast, other applications of surge suppression systems (e.g., lightning protection) can accommodate rise times of 8 uS, and so inductance is a lesser concern.

FIG. 2 is a schematic illustration of a surge suppressor system with a return conductor, a configuration that can provide surge suppression with the desired inductance. A surge arrestor element 22, e.g., a metal oxide varistor or a stack of metal oxide varistors, can be mounted within a return conductor 21. The return conductor 21 can be spaced farther from the surge arrestor element at the high voltage end than at the low voltage end, providing adequate electrical isolation. The return conductor can be connected to the reference voltage (e.g., ground).

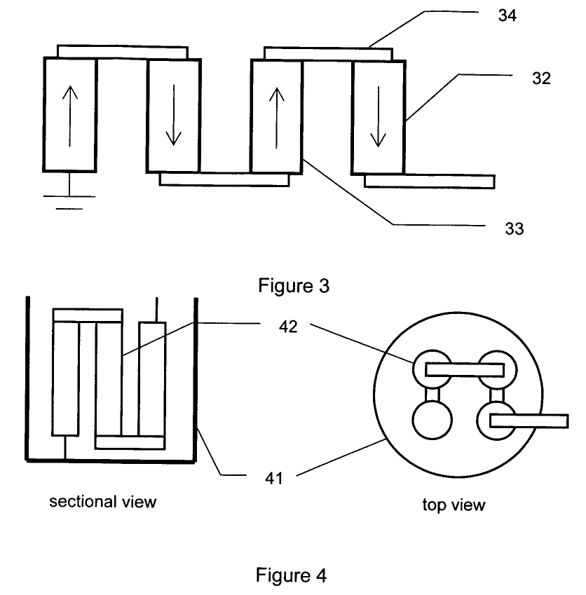

FIG. 3 is a schematic illustration of a surge suppressor system having a plurality of surge arrestor elements in a series circuit and arranged such that current flows in opposite directions in adjacent surge arrestor elements (e.g., 32, 33). The total length of surge arrestor element required can be divided into a plurality of individual surge arrestor elements. The surge arrestor elements can be connected (e.g., with connector such as 34) in a series electrical circuit, and mounted such that current in adjacent surge arrestor elements flows in substantially opposite directions. The net magnetic field is thereby reduced, and consequently the effective inductance is also reduced. While FIG. 3 shows the surge arrestor elements disposed along a line for ease of illustration, they can be configured along a curve in two dimensions, or in various other arrangements that maintain the opposing direction current characteristic. FIG. 4 is a schematic illustration of a surge suppressor apparatus similar to that on FIG. 3, with the surge arrestor elements (e.g., 42) configured along a curve, and mounted within a conducting container 41. The container is depicted with a circular cross section for ease of illustration, but can in general have any appropriate shape. The addition of the conducting container can further reduce the inductance of the surge suppression system.

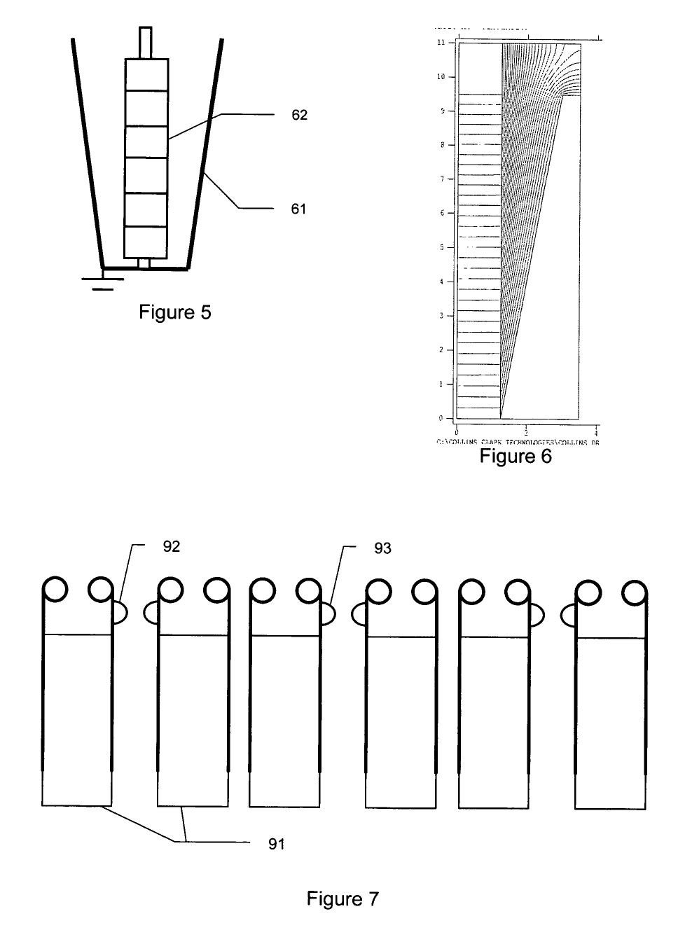

FIG. 5 is a schematic illustration of an example circuit for a pulsed power system incorporating a surge suppressor according to the present invention. It is similar in operation to the circuit shown in FIG. 1. As discussed before, the stray inductance in the surge suppression portion of the circuit can limit performance for some applications. As a specific example, low voltage, low current applications, addressed with relatively small numbers of metal oxide varistors (e.g., 50 kv, 5 ka, 5 disks) can achieve adequate performance without special regard to inductance of the surge suppression system. Inductance can have a significant detrimental effect on performance in higher power applications (e.g., 500 kv, 50 ka, 50 disks).

FIG. 6 is a schematic illustration of a surge suppressor system having a plurality of surge arrestor elements disposed within and coaxial with a return conductor, a configuration that can provide desired surge suppression with acceptably low inductance. A stack of metal oxide varistors 62, e.g., 5 to 10 disks capable of 50-100 kV each, provides a surge arrestor element. The surge arrestor element can be mounted with a return conductor 61 that effectively surrounds the surge arrestor element in directions perpendicular to the direction of current flow through the surge arrestor element. In the figure, the stack is mounted with a coaxial, conical conducting container that can be designed to withstand the required electric fields. Current flows into the stack at the top (in the figure) and exits at the bottom (in the figure). Because the bottom of the stack is in electrical contact with the container, the current flows back up the container and exits at the rim. Because equal and opposite currents flow in the metal oxide varistor stack 62 and the container 61, substantially all magnetic field energy is trapped between the two and does not extend past the container. Inductance is thus greatly reduced from that of an unshielded stack.

Managing electrostatic breakdown between the stack and the container can be an important design consideration. The trapezoid sectional shape, close to the stack at the bottom and further away at the rim, can further reduce inductance while still allowing adequate breakdown protection.

FIG. 7 is a graph of two dimensional electrostatic simulation results for the system depicted in FIG. 6. Well known empirical design criterion dictate the maximum electric field (hence the minimum distance between metal oxide varistor stack and container wall). Since the stack voltage is greatest at the rim, the gap there must generally be the largest. In practice, the system can include an insulating baffle at the output so that the stack can be immersed in an insulating medium, such as transformer oil or sulfur hexafloride gas. Also, the stack can be secured by, for example, welding the disks together or using a pressure clamp.

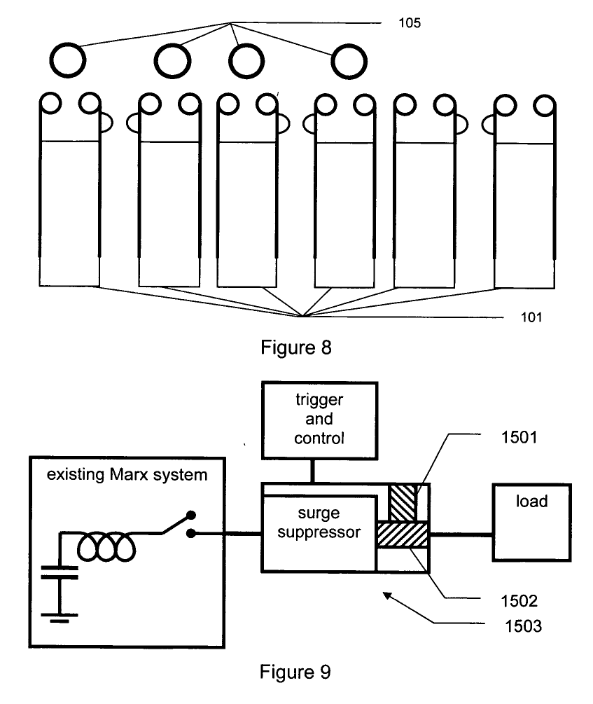

FIG. 8 is a schematic illustration of an example circuit for a pulsed power system incorporating a surge suppressor according to the present invention. In operation, the capacitor C1 is initially charged to a constant voltage. When switch S1 is closed, current flows through inductor L1 and through the surge suppressor system SSS (as long as the voltage exceeds the surge suppressor system clamp voltage). This can result in a substantially constant voltage pulse across the surge suppressor system while the current through the surge suppressor system is a strong function of time. At the proper time in the discharge, switch S2 can be closed, connecting the load resistor R1 and transferring surge suppressor system current to the load resistor R1.

In many applications, the rise-time and pulse-width of the voltage across the load resistor can be important parameters. In prior art systems, these two parameters were set by the design of the system and were difficult or impossible to alter without fundamental changes in design.

The present invention can comprise a simple technique, unique to the surge suppressor system, in which both of these parameters can be easily adjusted. Because of the non-linear nature of the surge suppressor system (e.g., one incorporating metal oxide varistors), the rise-time into the load resistor is a strong function of the time at which switch S2 is closed. When fired at T=0, i.e. simultaneously with closing of S1, the rise-time is relatively slow. As the time delay between S1 closing and S2 closing increases, the rise-time is decreased, reaching a minimum value related to stray circuit inductances associated with the load. The pulse-width is a strong function of the value of inductor L1. As its value is increased, the effective pulse-width is increased. An example embodiment can employ a mechanical shorting rod to eliminate or include turns on the inductor and provide the necessary adjustments. The adjustments to switch timing and inductance are only mildly dependent on each other, allowing a simple computer controlled system to set both rise-time and pulse-width.

FIG. 7 is a schematic illustration of a Marx generator having switches according to the present invention. A simple method of generating high voltage pulses, the Marx generator employs a set of capacitors (e.g., capacitors 91) that are charged in parallel to the same voltage, typically 50 kv-100 kv. Once the capacitors are fully charged, the switches 92, 93 are fired connecting the chain in series. Just as with batteries connected in series, the voltages add to produce the required output pulse (6× the charge voltage in the system of FIG. 7).

The switches can be important components in the performance of a Marx system. They must not only hold the charge voltage, they must also be triggered to close simultaneously in order to produce the required output. Triggering of these switches can be accomplished in several ways. One conventional method is a high voltage, very fast electrical pulse applied to a trigger electrode in each switch. While quite effective, the required hardware and voltages make this scheme awkward, large and unreliable. Another conventional method to trigger the Marx switches is through the use of lasers. An example of this method uses a simple Nitrogen laser operating in the ultraviolet part of the spectra. The hardware is simple, requiring only optical components (lenses, fiber optics etc) and thus quite compact. A significant problem with this technique is that it will only work for a sufficiently fast charge rate for the Marx capacitors. This time dependence on capacitor voltage severely restricts its use.

The present invention can comprise a new technique in which the electrical and laser triggering schemes are combined. An electrical trigger 92 is applied only to the first switch in the chain, the one closest to ground. All other stages utilize the laser technique, e.g. switch 93 in the figure. After the Marx capacitors are fully charged, the electrical trigger 92 at stage one is fired. When this switch closes, a fast rising voltage pulse is coupled forward to the other stages. This fast rising voltage now provides the required time dependence to allow the laser triggering to be used. The use of this combined technique eliminates the majority of hardware and complexity associated with electrical triggering and enables the simple technique of laser triggering. This method can be optimized by integrating the switches into the capacitor grading structure as seen in FIG. 7. The switch electrodes can be hollow and can be aligned so that a single laser located at the ground end of the Marx can pass a beam through the entire set of switches.

One issue that can affect the performance of a pulsed power system using a surge suppression system according to the present invention is the inductance associated with current flowing in the surge suppression system. The surge suppression systems previously described can provide a basis for a solution. Since the surge arrestor elements are generally limited to relatively low voltage (50-100 kv), a plurality of them must be connected in series for high voltage (˜>500 kv) applications. They can be arranged in as tight a package as possible to minimize the stray inductances between the modules. This can be complicated by the fact that each subsequent surge arrestor element is charged to a higher voltage than the previous one. Too close a spacing can result in electrical breakdown (arcing) between the surge arrestor elements or to ground.

FIG. 8 is a schematic illustration of a Marx generator having switches and a surge suppressor system according to the present invention. Surge arrestor elements 105 are disposed in relation to the Marx generator, such that each surge arrestor element mounts proximal a Marx stage 101 with a similar operating voltage. This optimization is possible because each stage of the Marx generator adds to the voltage of the previous stage in a similar manner as the voltage change across the plurality of surge arrestor elements. In FIG. 8 a six stage Marx is shown along with four surge arrestor elements.

For illustration assume that each stage is initially charged to 100 kv, resulting in a 600 kv total “erected” voltage after Marx switches are fired. At that point, for instance the third stage would have a 300 kv potential relative to ground. If the surge arrestor elements are designed to have the same 100 kv potential when current flows, each one can be arranged next to a Marx stage with the same potential. In this way the Marx stages and the surge arrestor elements help shield one another, reducing the total inductance. This is a packaging scheme for an integrated system, where the Marx system and the surge suppression system are designed together as a single system. For applications where a surge suppression system is to be added to an existing Marx system, alternate packaging can be desirable and is described elsewhere herein.

In some applications, an existing pulsed power circuit can benefit from the incorporation of the present invention, but redesign or rebuilding the existing system to accommodate features as discussed elsewhere herein can be prohibitive in cost or time. A surge suppression system according to the present invention can be retrofitted onto such existing pulsed power systems. As shown in FIG. 9, an existing pulsed power system can be viewed as incorporating an energy source and an inductor. A surge suppression system 1503 can be added to such an existing system, for example as a complete package including all hardware and control devices (e.g., an output switch 1502 and a crowbar switch 1501) to allow independent operation of the surge suppressor system 1503 in connection with the existing pulsed power system.

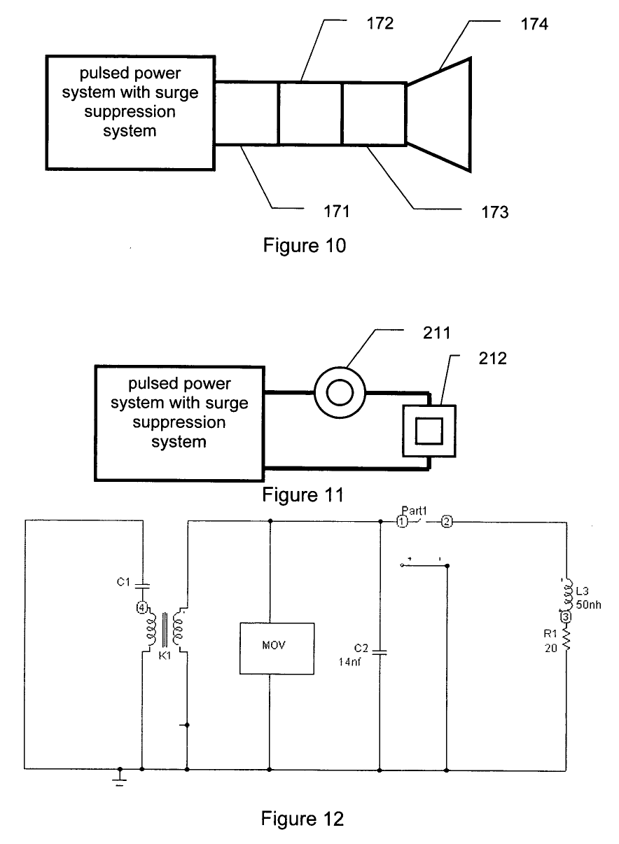

The present invention can comprise a system such as that in FIG. 10, comprising a surge suppression system and pulsed power circuit as described before, as applied to driving an “active” high power microwave load (e.g., an electron beam generation section 171, a microwave generation section 172, a mode conversion section 173, and an antenna section 174). There are a number of specific high power microwave tubes in existence. They generally operate in the 100 kV-1000 kV and require pulsed power risetimes of less than about 100 nS. The tubes differ in their operating impedance ranges. Examples of such tubes include Split Cavity Oscillator (SCO): 200 kV, 200 ohms, >10 MegaWatts radiated; Relatron: 600 kV, 1000 Ohms, >100 MegaWatts radiated; Relativistic Magnetron (RELMAG): 500 kV, 40 Ohm, >100 MegaWatts radiated; Virtual Cathode Oscillator (VIRCATOR): 500 kV, 20 Ohm, >500 MegaWatts radiated; Relativistic Klystron Oscillator (RKO): 500 kV, 20 Ohm, >500 MegaWatts radiated; Magnetic Insulated Line Oscillator (MILO): 500 kV, 8 Ohm, >500 MegaWatts radiated.

Each of these tubes presents a unique, dynamic load and thus unique pulsed power requirements. A pulsed power system including a surge suppression system according to the present invention can be designed to drive each of these tubes and thus other tubes in the same range. The ability to drive dynamic loads of impedance ranging from <10 Ohms to >100 Ohms represents a capability that is not possible with any single prior art pulsed power system.

A pulsed power system according to the present invention can be applied as shown in FIG. 11, using either the inductive circuit or the resistive circuit. In the application illustrated, an external device under test can be connected across output terminals of the system. As examples, such a device can be either a voltage probe 212 or a current probe 211 needing calibration. A very fast rise (<10 nS), long (>1 uS), very flat pulse (˜+/−2%) pulse is provided. Calibrated probes internal to the system can provide reference signals. The combination of fast rise with long pulse allows calibration of the probes over a broad frequency range at high power in a single device. In this way all non-linearity in the probe response can be ascertained with a single device.

The present invention can also be suitable for use with transformer-based pulsed power systems, such as that depicted schematically in FIG. 12. With a transformer-based system, the initial energy store can be in a capacitor located in the primary circuit at relatively low voltage. Discharge through the primary circuit can couple energy into the secondary circuit with a resulting voltage increase given by the transformer turns ratio. For certain applications, the ability to store energy at low voltage outweighs the disadvantage of storing the energy twice, first in the primary and then in the secondary capacitor. The present invention can comprise a surge suppressor system (such as a metal oxide varistor element or elements) to provide voltage shaping without the need for any pulse forming element. In operation, capacitor C1 discharges through the primary of transformer K1 producing a voltage on capacitor C2 and the surge suppression system. With proper choice of parameters, the surge suppression system can clamp the voltage across capacitor C2. At the appropriate time, switch PART 1 can be closed connecting the load resistor R1. Typical resulting waveforms are shown in FIG. 13. Note that the load voltage has a steep risetime and a long period of substantially constant voltage.

Materials and Methods. Surge arrestors are commercial off the shelf (COTS) products utilized in numerous commercial and consumer products to protect sensitive electronic devices from electrical transients such as lightning strikes. Examples range from industrial facility protection to personal computer surge protection power strips. For use in the current invention, several COTS components are readily available. The General Electric model 9L26ZNW3228S FB-02 D and the Panasonic model ZNR20182 have been used in example implementations of this invention.

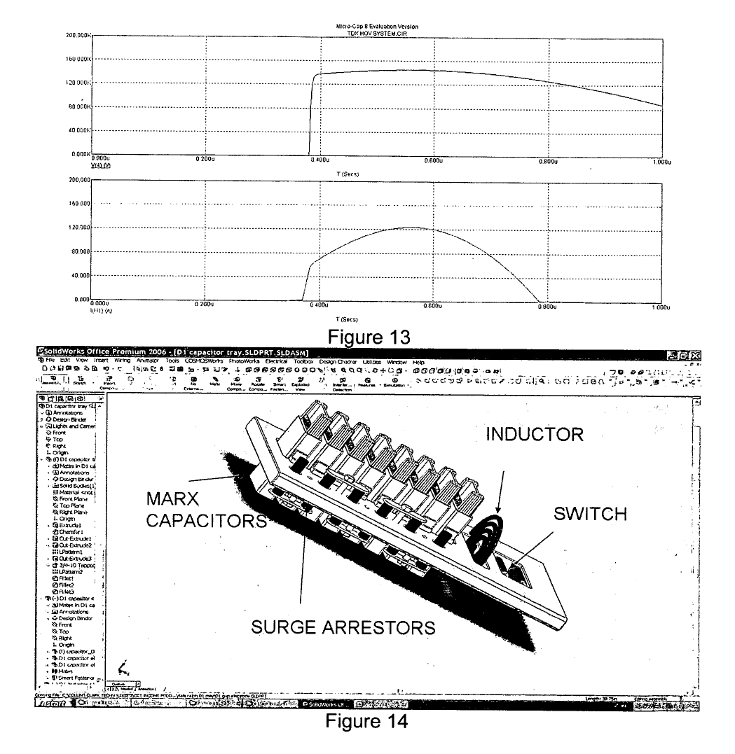

Example Embodiment. A specific implementation of the present invention is shown in FIG. 14. The various components are identified and are the physical embodiments of the components in the circuit diagram in FIG. 1. All components are mounted in a dielectric plate 20″×30″×2″ thick and are assembled and installed with conventional pulsed power techniques and tools. Non-COTS components such as capacitor mounting hardware, inductor hardware, Marx switch hardware and output switch hardware are fabricated with conventional manufacturing techniques. This hardware is designed to drive a high power microwave load at 500 kilovolts, 10 kiloamperes, 200 nanoseconds. Those skilled in the art will appreciate several peripheral yet important components such as charge resistors, trigger components and high pressure containment vessel, not shown in the diagram but common to pulsed power systems.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

1) A surge suppressor apparatus suitable for use in a pulsed power system, comprising a plurality of surge arrestor elements, each having first and second terminals, and disposed in series, wherein:
a) the first surge arrestor element in the series has a first terminal adapted to be placed in electrical communication with an external circuit;
b) the last surge arrestor element in the series has a second terminal adapted to be placed in electrical communication with an external circuit;
c) each surge arrestor element in the series other than the last has a second terminal in electrical communication with the first terminal of the next surge arrestor element in the series; and
d) the surge arrestor elements are mounted relative to each other such that electrical current in one surge arrestor element is in a direction substantially opposite electrical current in an adjacent surge arrestor element.

2) An apparatus as in claim 1, wherein the surge arrestor elements are mounted relative to each other such that electrical current in each surge arrestor element is in a direction substantially opposite electrical current in an adjacent surge arrestor element.

3) An apparatus as in claim 1, wherein each surge arrestor element defines an axis substantially parallel to the direction of current flow in the surge arrestor element, and wherein the surge arrestor elements are mounted with each other such that their axes are substantially parallel.

4) An apparatus as in claim 3, wherein, for each surge arrestor element, the first terminal thereof is mounted with a first end thereof and the second terminal thereof is mounted with a second end thereof, and wherein the first end of each surge arrestor element is mounted proximal the second end of an adjacent surge arrestor element.

5) An apparatus as in claim 3, wherein the surge arrestor elements are mounted with each other such that their axes intersect a substantially straight line.

6) An apparatus as in claim 3, wherein the surge arrestor elements are mounted with each other such that their axes intersect a curve in two dimensions.

7) An apparatus as in claim 1, wherein the surge arrestor elements comprise metal oxide varistor elements.

8) An apparatus as in claim 1, wherein the terminals are connected by metallic elements placed in physical contact with the elements.

9) An apparatus as in claim 8, wherein the metallic elements are urged against the terminals.

10) A system for producing a shaped electrical waveform, comprising:
a) An electrostatic energy storage system, having a reference terminal adapted to be placed in electrical communication with a reference potential, and having an output terminal;
b) An inductor, having an input terminal in electrical communication with the output terminal of the electrostatic energy storage system, and having an output terminal;
c) A surge suppressor apparatus as in claim 1, wherein the first terminal of the first surge arrestor element in the series is in electrical communication with the output terminal of the inductor, and wherein the second terminal of the last surge arrestor element in the series is adapted to be placed in electrical communication with the reference potential.

11) A system as in claim 10, wherein the electrostatic energy storage system comprises a plurality of capacitors mounted relative to each other, wherein the surge arrestor elements mount relative to the plurality of capacitors such that capacitors charged to higher potential relative to the reference potential are mounted closer to surge arrestor elements at higher potential relative to the reference potential in operation than to surge arrestor elements at lower potential relative to the reference potential in operation.

12) A system as in claim 10, wherein the electrostatic energy storage system comprises a plurality of capacitors mounted relative to each other, wherein the surge arrestor elements mount relative to the plurality of capacitors such that each surge arrestor element mounts proximal to a capacitor that is charged to a voltage similar to the voltage present at the surge arrestor element in operation.

13) A system as in claim 10, wherein the surge arrestor elements comprise metal oxide varistor elements.

14) An apparatus as in claim 1, wherein the surge arrestor elements are mounted relative to each other such that electrical current in one surge arrestor element is in a direction substantially parallel to but substantially opposite the direction of electrical current in an adjacent surge arrestor element.

15) An apparatus as in claim 1, wherein the surge arrestor elements are mounted relative to each other such that electrical current in each surge arrestor element is in a direction substantially parallel to but substantially opposite the direction of electrical current in an adjacent surge arrestor element.

16) A surge suppressor apparatus suitable for use with a pulsed power system, comprising:
a) A first surge arrestor element, having a first terminal adapted to connect with an external circuit, and a second terminal spaced apart from the first terminal by a material suitable for use as a surge arrestor;
b) A second surge arrestor element, having a first terminal adapted to connect with an external circuit, and a second terminal spaced apart from the first terminal by a material suitable for use as a surge arrestor;
c) A connection element mounted with the first and second surge arrestor elements such that their second terminals are in electrical communication with each other;
d) Wherein the first surge arrestor element mounts relative to the second surge arrestor element such that current flow in the first surge arrestor element is substantially parallel to, but in opposite direction to, current flow in the second surge arrestor element.
e) An apparatus as in claim 16, wherein the surge arrestor elements comprise metal oxide varistors.

17) A surge suppressor system suitable for use in a pulsed power system, comprising:
a) A surge arrestor element having first and second ends between which current flows in operation;
b) A return conductor in electrical communication with the surge arrestor element proximal the first end thereof, and configured such that the return conductor effectively surrounds the surge arrestor element in directions perpendicular to the direction of current flow through the surge arrestor element in operation.

18) A system as in claim 17, wherein the return conductor is spaced apart from the surge arrestor element by a first distance near the first end of the surge arrestor element, and by a second distance, greater than the first distance, near the second end of the surge arrestor element.

19) A system as in claim 17, wherein the return conductor comprises a substantially solid surface surrounding the surge arrestor element in directions perpendicular to the direction of current flow through the surge arrestor element in operation.

20) A system as in claim 17, wherein the return conductor comprises a plurality of conductive elements disposed about the surge arrestor element such that each conductive element is separated from the surge arrestor element by respective first distance near the first end of the surge arrestor element and by a respective second distance, greater than the first distance, near the second end of the surge arrestor element.
